(19) United States
(12) Patent Application Publication
(10) Pub. No.: US 2013/0185100 A1
(43) Pub. Date: Jul. 18, 2013

(54) Method and System For Assessing Property Loss In A Catastrophe

(71) Applicant: Marshall P. Allu, Fort Washington, PA (US)

(72) Inventor: Marshall P. Allu, Fort Washington, PA (US)

(21) Appl. No.: 13/740,341

(22) Filed: Jan. 14, 2013

Related U.S. Application Data
(60) Provisional application No. 61/587,182, filed on Jan. 17, 2012.

(51) Int. Cl. G06Q 40/08; G06Q 50/18

(52) U.S. Cl. CPC G06Q 40/08; G06Q 50/18
USPC 705/4

(57) ABSTRACT

The present invention provides for a method of assessing lost property after a catastrophe which would be covered under an insurance policy and overcomes the deficiencies of prior methods to provide an improved method for identifying property at the time of loss for both commercial and residential policies. A legal review provides a policy customized for the individual policy holder. Maintenance of a digitized detailed record of all items covered under the insurance policy is established and verified at the beginning of coverage or at a time point prior to a catastrophic event so that if a catastrophic event results in complete loss of covered property or property is destroyed beyond identification, 100% of the covered property is accurately and verifiably recorded for replacement/reimbursement purposes.

### RELATED APPLICATIONS

This application claims the benefit of U.S. Provisional Patent Application No. 61/587,182, filed Jan. 17, 2012, the disclosure of which is incorporated herein by reference.

### FIELD OF THE INVENTION

This invention relates to systems and methods for processing insurance claims. More specifically, a system is provided for rapidly determining the value of property loss after a catastrophe.

### BACKGROUND

In a typical insurance claim, an insured submits a claim to an insurance company for costs associated with property damage, and the insurance company pays the claim. Currently, the value of the claim is determined at the time of loss and requires an assessment by the insured, usually with the aid of an insurance adjuster. One challenge in this determination is attempting to accurately determine the items lost or damaged, especially after a catastrophe or major disaster.

Insurance companies rely on the methods of a claim adjuster to determine the value of the loss and provide coverage based on this assessment. However, these traditional methods are inadequate, expensive, time consuming, and generally result in adjustment values of approximately 20% less than the actual loss. This is in part because the insured must provide a detailed recollection, usually from memory and at the time of loss, of all items covered under the policy. They also may be asked to recollect the purchase price, age, or quality of the lost item among other characteristics. Adjusters use this information to follow their standard review process for recommending reimbursement on a claim. Such a method is inadequate to identify all recoverable items because the determination by the adjuster is subjective, based on experience and knowledge of the adjuster, and is difficult, if not impossible, to completely detail at the time of loss. As such, the quality and consistency of claim adjusters will vary, leading to inconsistent and missed assessments in some cases. To further burden the system, the cost for the services of an adjuster is factored into the premiums paid by the insured, increasing the cost for insurance and adding an extra burden on an already over taxed insurance system.

Simple automation in the identification of personal possessions does not provide a verifiable record that can be used at a later date in assessing loss. U.S. pat. No. 5,841,116 describes an automated means for identifying personal possessions however merely labeling and indexing possessions prior to a disaster does not provide a secure and verifiable means for assessing value.

Therefore a method and system for identifying personal property after loss which is rapid and inexpensive and having a verifiable, accurate description of the property is desirable, especially after a catastrophe or major disaster.

### SUMMARY OF THE INVENTION

Systems consistent with the present invention overcome the deficiencies of prior methods and provide an improved method for identifying property at the time of loss for both commercial and residential policies. Maintenance of a digitized detailed record of all items covered under the insurance policy is established and verified at the beginning of coverage or at a time point prior to a catastrophic event so that if a catastrophic event results in complete loss of covered property or property is destroyed beyond identification, 100% of the covered property is accurately and verifiably recorded for replacement/reimbursement purposes.

In an embodiment of the present invention, a detailed record of all possessions is obtained by establishing a preexisting property record (PPR) consisting of digitized images for all items insured under the policy. A PPR provides a detailed and verifiable log of all items under the insurance policy. PPR's are retained by secure, off-site storage means with a certified copy provided to the insured.

Another embodiment utilizes a video in establishing the PPR. Similar to digitized images, the video creates a detailed and verifiable record of all items under the coverage.

In another embodiment, the preexisting property record is incorporated into a customized insurance policy which undergoes legal review to assess the risk to the insured. Accordingly when a person or commercial entity contract for an insurance policy to indemnify them against loss of property, the terms of the policy are customized to the needs of the individual party insured under the policy.

In still another embodiment of the present invention, a scanner is provided at the insured's residence for obtaining digitized images or videos of sales receipts and/or images of the items which are verified and stored in the PPR. This embodiment provides a “real-time” log of the insured's property and establishes a detailed and verifiable record of new or additional items under the policy.

These embodiments provide a verifiable list of lost items for rapid valuation of lost property.

Still another embodiment of the present invention provides each insured with at least one emergency broadcast device such as a radio or smart phone app in the event of a national disaster so the insured can maintain contact with the outside world for information from official governmental agencies of where to gain shelter and update information for survival. The invention will also provide information to the insured on emergency egress from second and third floors of homes and businesses which it serves. The invention will also check the status of all carbon monoxide, smoke and fire alarms to ensure they are provided and in good working order.

Still another embodiment will provide a plan of where to go if an emergency evacuation is required and a plan to reunite family members if separated during a disaster. Another feature of this invention is that it will inform each insured of prevailing winds using a communication device such as an app for a smart phone for each locality that the insured resides. This information is vital if a disaster occurs from chemical, biological, nuclear accidents or war. Another embodiment of this invention will to aid the insured with recovery of losses that are not recovered from insured policies for example, but not limited to, reimbursement under the IRS tax code.

Another embodiment of the present invention provides a detailed record of all possessions associated with divorce proceedings, identifying all possessions of both individuals before and after marriage. A record of all possessions is obtained by establishing a PPR consisting of digitized images for all items either individual or jointly owned. A PPR provides a detailed and verifiable log of all items specifying ownership. PPR's are retained by secure, off-site storage means with a certified copy provided to the couple.

The present invention has applications in probating an individual's property where a PPR provides a detailed record. Further the present invention is useful in bankruptcy or liquidation proceedings where a verifiable record of property is needed.

### BRIEF DESCRIPTION OF THE DRAWINGS

The various objects, advantages and features of the present invention will become more apparent to one skilled in the art from the following detailed disclosure and claims when read in conjunction with the accompanying drawings in which:

FIG. 1 Flow chart showing steps involved in developing PPR with property loss.

### DESCRIPTION OF THE BEST EMBODIMENTS CONTEMPLATED

Processing, tracking and releasing funds for claims made upon insurance policies are all time intensive and resource intensive. Traditionally, there are six major steps involved in the processing of claims: initial claims processing, loss appraisal, claims adjusting, satisfying the claim, and settlement and payment.

Prior methods begin with initial claims processing which includes receiving initial data associated with a newly asserted claim and an initial assessment of damages. The claims process starts with a notification by the insured that a fire, tornado, hurricane, or theft has occurred. Currently, this notification is typically completed by phone to the carrier's agent. The carrier then verifies policy coverage, creates a claim file and assigns the claim to an adjuster and an appraisal resource.

Loss appraisal involves valuation and assessment of the loss. For most insurance claims including but not limited to fire or other catastrophic loss, there will be items which are not recoverable or identifiable so determining the quantity and quality of all the lost items can only be obtained after the occurrence of the catastrophic event and by recall of the record.

Claims adjusting involve determining the fair claim settlement amount. Claims adjusting include investigating the facts related to the claim and settlement negotiations with the insured. Traditionally, this process is handled by a claim adjuster, and requires data from a wide and disparate variety of internal and external sources for valuation, including discussion with the insured and the experience of the adjuster.

Satisfying the claim involves completing any services or payments that are required to recompense the loss. The traditional process involves delays in compensation until finalization by adjusters. The present process helps the insured by avoiding the subjective analysis of an adjuster and related costs, ensuring a rapid valuation for settlement of the claim, and reducing overall cost of insurance.

The present method also benefits insurance companies by reducing their claims expenses, increasing the premiums from undervalued buildings and contents coverage. In addition the method will include added premiums from all inland marine coverage such as, but not limited to, jewelry, antiques, oriental rugs, and all types of collections. Most importantly, the present method will promote good will between the companies, their currently insured client and all future clients.

The present method is an invaluable tool to inventory property in divorce cases identifying each party's owned property prior to the marriage and during the marriage prior to the divorce proceedings and in all estate property, and all bankruptcy and liquidations of all businesses.

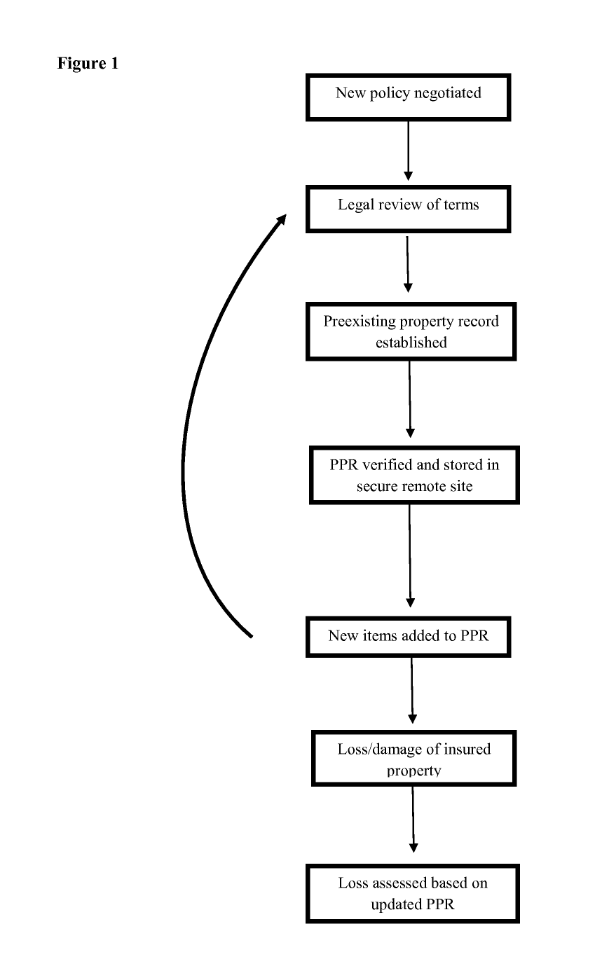

The method of the present invention is appropriate for insuring individuals or large commercial entities. As shown in FIG. 1, the process of the present invention begins with the establishment of policy terms that are customized to the needs of the insured through a complete legal assessment. To ensure the correct building and amount/type of contents coverage to replace both the contents and building to 100% of its value before the loss, the legal assessment will separately confirm the proper endorsements and scheduling of certain items such as, but not limited to, jewelry, fine arts, and antiques. Clauses are inserted into the policy to guarantee full replacement and minimize future litigation costs and delays of payment to the insured by the insurance companies. This legal review will also minimize the need for the service of Public Adjusters, thus reducing the overall costs and passing huge savings to the insured as Public Adjuster fees can be up to 30% of the claims eventually recovered. Public Adjusters charge the policyholder if the Public Adjusters recover losses from the insurance companies. These Public Adjuster fees are deducted from the final settlement received from the insurance companies. The fees are similar to having a huge deductible at the time of loss.

At the establishment of the policy, a digitized image or video of all items covered under the policy is recorded to create a preexisting property record (PPR). The digitized image or video can be obtained by any means known. Further, automated means are considered in the present invention incorporating a robotic process for acquiring images. A PPR allows for a complete record of the insured's property prior to any claim or loss. The PPR provides a detailed and verifiable record maintained at a secure off-site location. The insured receives a copy of the record for their records. An update may not be necessary. However in certain policies, a continued update of the PPR may be required. The frequency and items updated will depend upon the needs of the insured and the terms of the policy. Another copy is stored remotely, preferably through an electronic storage means. Suitable storage means include, but not limited to, cloud computing, automated computing, client-server storage, grid computing, mainframe computing, or combinations thereof. Optionally, a scanner is used to obtain a digitized record of sales receipts and/or images of the item which establishes a “real-time” log of new items to be further added to the policy. The scanned image is verified and added to the PPR for the policy.

When or if a claim is submitted by the insured for a loss, the updated PPR is quickly reviewed for valuation of all loss items. The services of a claims adjuster are eliminated with 100% of the covered property accurately known for replacement or reimbursement.

While this invention has been described with respect to various specific examples and embodiments, it is to be understood that the invention is not limited thereto and that it can be variously practiced within the scope of the following claims.

1- A method for assessing the loss of personal property after a catastrophe comprising:
a. establishing a customized policy for an insured;
b. creating a preexisting property record;
c. verifying the preexisting property record;
d. storing said record at a remote storage site; and
e. valuating all property lose from the catastrophe based upon said preexisting property record.

2- The method of claim 1 wherein the customized policy is a legal review to assess the risk to the insured.

3- The method of claim 1 wherein the preexisting property records are digitized images for all items under the insurance policy.

4- The method of claim 1 wherein the preexisting property record is a detailed video for all items under the insurance policy

5- The method of claim 1 wherein the remote storage site is by cloud computing.

6- The method of claim 1 wherein the remote storage is verified using a scanner to obtained digitized images of sales receipts.

7- The method of claim 1 further including the step of providing the insured with an emergency broadcast communication device.

8- The method of claim 1 further including the step of assessing emergency egress from second and third floors.

9- The method of claim 1 further including the step of checking the status of carbon monoxide, smoke and fire alarms.

10- The method of claim 1 further including the step of providing a plan for emergency evacuation wherein the plan includes a means to reunite family members separated during the disaster.

11- The method of claim 1 further including the step of informing the insured of prevailing winding winds in each locality.

12- The method of claim 1 further providing tax information to the insured on recovery of losses not recovered from the policy.

13- A method for assessing property in a divorce comprising:
a. creating a preexisting property record prior to a divorce wherein the record specifies ownership and circumstances of ownership;
b. verifying the preexisting property record;
c. storing said record at a remote storage site; and
d. valuating all property based upon said preexisting property record.

14- A method for assessing property in legal proceedings comprising:
a. creating a preexisting property record prior to a legal proceeding;
b. verifying the preexisting property record;
c. storing said record at a remote storage site; and
d. valuating all property based upon said preexisting property record.

15- The method of claim 14 wherein the legal proceeding is selected from the group consisting of probate, bankruptcy, and liquidation.
